(19) United States
(12) Patent Application Publication
(10) Pub. No.: US 2007/0103942 A1
(43) Pub. Date: May 10, 2007

(54) Backlight module, inverter, and DC voltage generating method thereof

(75) Inventors: Guo-Kiang Hung, Sindian City (TW); Song-Yi Lin, Taipei (TW)

Correspondence Address: BACON & THOMAS, PLLC, 625 SLATERS LANE, FOURTH FLOOR, ALEXANDRIA, VA, 22314, US

(73) Assignee: Mstar Semiconductor, Inc., Chu Pei (TW)

(21) Appl. No.: 11/440,108

(22) Filed: May 25, 2006

(30) Foreign Application Priority Data
Nov. 8, 2005 (TW) 94219335
Nov. 24, 2005 (CN) 200510128701.4
Nov. 24, 2005 (CN) 200520122383.6

(51) Int. Cl. H02M 3/335

(52) U.S. Cl. 363/17

(57) ABSTRACT

A backlight module, inverter, and DC voltage generating method thereof is disclosed. The inverter of the backlight includes a power converting device, a transformer, and a rectification circuit. The power converting device is coupled to a first DC voltage for outputting a first AC voltage. The transformer includes a primary coil, and a first secondary coil. The primary coil is coupled to the first AC voltage outputted by the power converting device. The first secondary coil is for outputting a second AC voltage by inducing the first AC voltage. The rectification circuit is coupled to the first secondary coil for rectifying the second AC voltage and outputting a second DC voltage.

This application claims the benefit of Taiwan application Serial No. 94219335, filed Nov. 8, 2005, the subject matter of which is incorporated herein by reference.

### BACKGROUND OF THE INVENTION

1. Field of the Invention

The invention relates in general to a backlight module, inverter and DC voltage generating method thereof, and more particularly to a backlight module and inverter, which can supply driving voltages to a display panel, and DC voltage generating method thereof.

2. Description of the Related Art

FIG. 1 is a block diagram of a conventional driving circuit for a small-scale liquid crystal panel using two DC driving voltages provided from the exterior. Referring to FIG. 1, the small-scale liquid-crystal-panel (LCD) driving circuit 100 requires two driving voltages, such as +15V and −10V, provided from the exterior in addition to an operation voltage 5V. A conventional LCD control circuit provides only a driving voltage under 5V. In order to generate the two high driving voltages, an additional DC/DC converter 110, such as a charge pump or a boost circuit, is disposed for converting the operation voltage 5V to the required driving voltages +15V and −10V. However, using the DC/DC converter 110 will increase the cost for manufacturing the LCD.

### SUMMARY OF THE INVENTION

It is therefore an object of the invention to provide a backlight module, inverter, and DC voltage generating method thereof. A secondary coil is added to the transformer of the inverter and coupled to a simple-structure rectification circuit for generating the required positive and negative driving voltages of the display panel. Therefore, the cost for manufacturing the LCD can be effectively reduced.

The invention achieves the above-identified object by providing an inverter applied to a backlight module. The inverter includes a power converting device, a transformer, and a rectification circuit. The power converting device is coupled to a first DC voltage for outputting a first AC voltage. The transformer includes a primary coil, and a first secondary coil. The primary coil is coupled to the first AC voltage outputted by the power converting device. The first secondary coil is for outputting a second AC voltage by inducing the first AC voltage. The rectification circuit is coupled to the first secondary coil for rectifying the second AC voltage and outputting a second DC voltage.

The invention achieves the above-identified object by providing another inverter applied to a backlight module. The inverter includes a power converting device, a transformer, and a first rectification circuit. The power converting device is coupled to a first DC voltage for outputting a first AC voltage. The transformer includes a primary coil and a first secondary coil. The primary coil is coupled to the first AC voltage outputted by the power converting device. The first secondary coil is for outputting a second AC voltage to drive the lamp by inducing the first AC voltage. The first rectification circuit is coupled to the primary coil for rectifying the first AC voltage and outputting a second DC voltage.

The invention achieves the above-identified object by providing a backlight module including an inverter and a lamp. The inverter includes a power converting device, a transformer, and a rectification circuit. The power converting device is coupled to a first DC voltage for outputting a first AC voltage. The transformer includes a primary coil, a first secondary coil and a second secondary coil. The primary coil is coupled to the first AC voltage outputted by the power converting device. The first secondary coil is for outputting a second AC voltage by inducing the first AC voltage. The second secondary coil is for outputting a third AC voltage by inducing the first AC voltage. The rectification circuit is coupled to the first secondary coil for rectifying the second AC voltage and outputting a second DC voltage. The lamp is coupled to the third AC voltage.

The invention achieves the above-identified object by providing a DC voltage generating method applied to an inverter of a backlight module. The inverter is for receiving a first DC voltage. The method includes converting the first DC voltage to a first AC voltage; converting the first AC voltage to a second AC voltage by an electromagnetic induction method; and rectifying the second AC voltage to generate a second DC voltage.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional driving circuit for a small-scale liquid crystal panel.

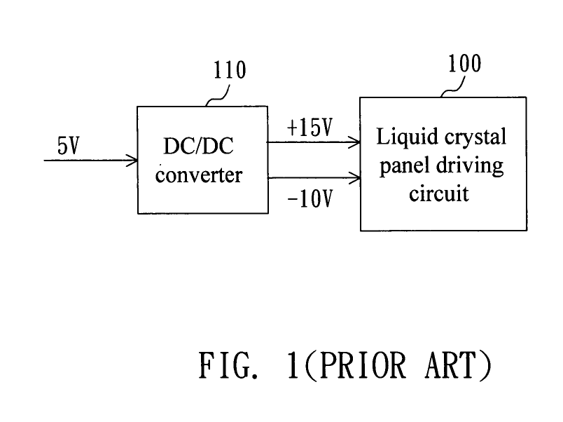

FIG. 2A is a circuit structure diagram of a backlight module of a LCD according to a first embodiment of the invention.

FIG. 2B is a flow chart of the method for generating a DC voltage according to the first embodiment of the invention.

FIG. 3A is a circuit structure diagram of a backlight module of a LCD according to a second embodiment of the invention.

FIG. 3B is a flow chart of the method for generating a DC voltage according to the second embodiment of the invention.

### DETAILED DESCRIPTION OF THE INVENTION

### Embodiment One

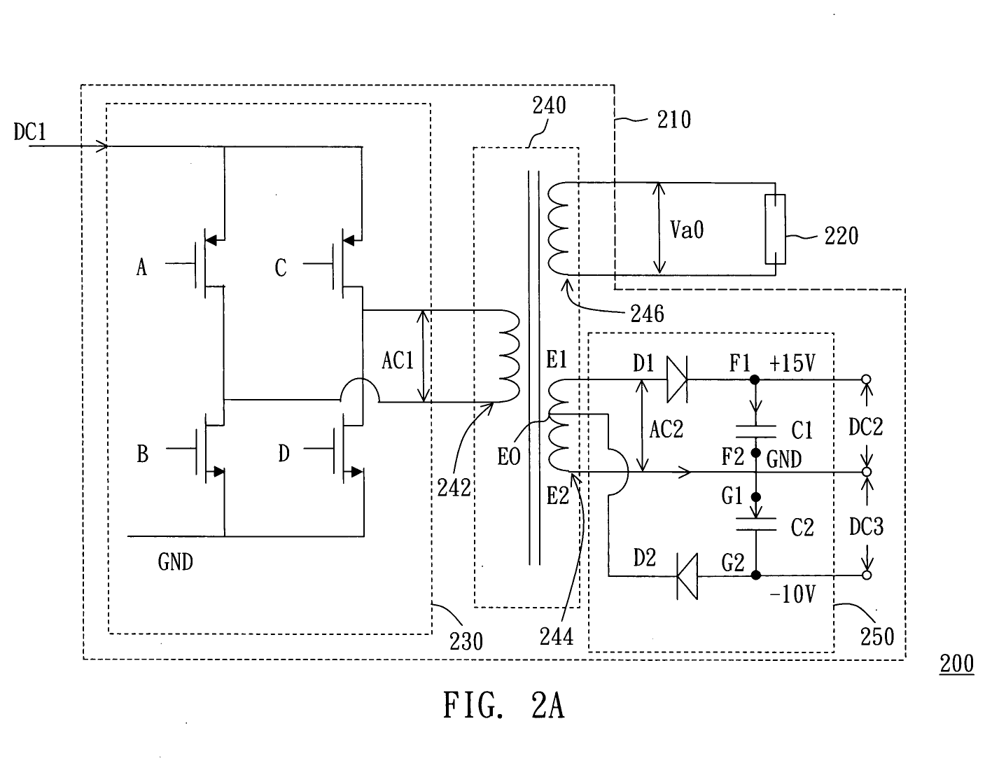

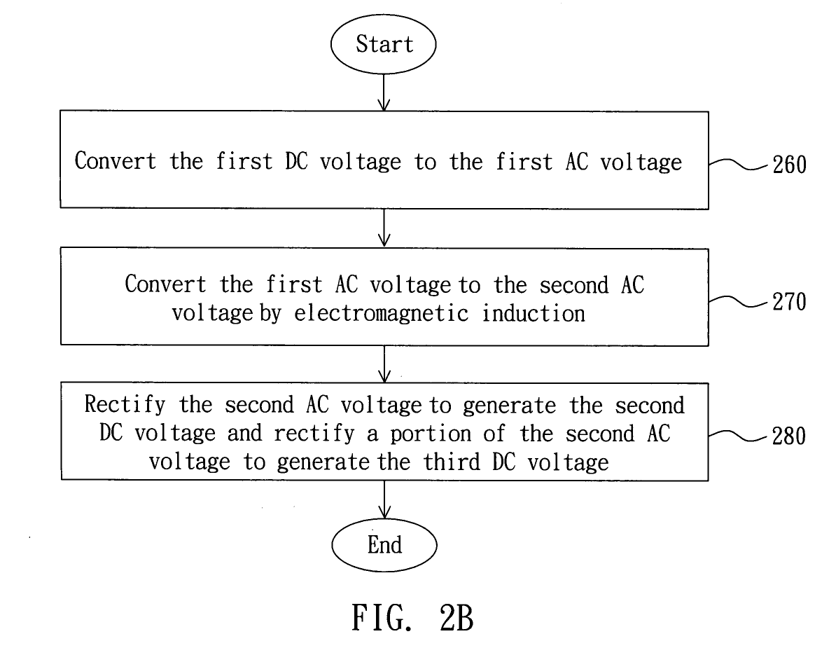

Referring to FIG. 2A, a circuit structure diagram of a backlight module of a LCD according to a first embodiment of the invention is shown. The backlight module 200 including an inverter 210 and a lamp 220 serves as a light source for a small scale liquid crystal panel,. The inverter 210 provides an AC driving voltage Va0 for driving the lamp 220. The lamp 220 is a cold cathode fluorescent lamp (CCFL) as preferred. The inverter 210 includes a power converting device 230, a transformer 240 and a rectification circuit 250. As shown in FIG. 2A, the power converting device 230, a full-bridge switch device as preferred, is coupled to the first DC voltage DC1, such as 5V (the DC voltage DC1 falls in the range (5V, 24V) as preferred), and converts the DC voltage DC1 to a first AC voltage AC1 through high-frequency switching.

The transformer 240 includes a primary coil 242, a first secondary coil 244 and a second secondary coil 246. The primary coil 242 is coupled to the first AC voltage AC1 outputted by the power converting device 230. The first secondary coil 244 induces the first AC voltage AC1 to generate the second AC voltage AC2 by electromagnetic induction. The second secondary coil 246 induces the first AC voltage AC1 by electromagnetic induction to output a third AC voltage Va0, up to several hundred to a thousand volts, for lighting up the lamp 220.

Besides, the rectification circuit 250 is coupled to the first secondary coil 244 for rectifying the second AC voltage AC2 and outputting the second DC voltage DC2 and the third DC voltage DC3, such as the driving voltages +15V and −10V. The rectification circuit 250 preferably includes diodes D1, D2 and capacitors C1, C2. The positive end of the diode D1 is coupled to an end E1 of the first secondary coil 244 while the negative end of the diode D1 is coupled to an end F1 of the capacitor C1. Another end E2 of the first secondary coil 244 is coupled to another end F2 of the capacitor C1 while the end F2 of the capacitor C1 is grounded.

Moreover, the positive end of the diode D2 is coupled to an end G2 of the capacitor C2, the negative end of the diode D2 is coupled to an inner node E0 of the first secondary coil 244, and another end G1 of the capacitor C2 is coupled to the end F2 of the capacitor C1.

FIG. 2B shows a flow chart of the method for generating a DC voltage according to the first embodiment of the invention. First, in step 260, also with reference to FIG. 2A, use the above-mentioned power converting device 230, such as the full-bridge switch device to convert the first DC voltage DC1 (such as 5V) to the first AC voltage AC1 by high-frequency switching. If the threshold voltages of the transistors A, B, C and D are not considered, the AC voltage AC1 has an amplitude about 5V in the embodiment. Next, in step 270, convert the first voltage AC1 to second AC voltage AC2 by electromagnetic induction. For example, the primary coil 242 of the above-mentioned transformer 240 receives the AC voltage AC1 and induces the AC voltage AC1 to generate the second AC voltage AC2 through the first secondary coil 244 by electromagnetic induction. Finally, in step 280, rectify the second AC voltage AC2 to generate the second DC voltage DC2 and rectify a portion of the second AC voltage AC2 to generate the third DC voltage DC3 by the above-mentioned rectification circuit 250.

In FIG. 2A, assume the winding number of the primary coil 242 is M, and the winding number of the first secondary coil 244 is N1. When N1 is equal to M×3, the first secondary coil 244 will induce the AC voltage AC1 (5V) to generate the AC voltage AC2 of 15V (3×5V). The AC voltage AC2 is rectified by the diode D1 to generate a DC voltage drop 15V (DC2) across the capacitor C1. That is, the Fl node is +15V. Assume the winding number of the first secondary coil 244 from the end E0 to E2 is N1′ and N′ is set to be N1×(⅔). The induced voltage on the first secondary coil 244 between the ends E0 and E2 is 15V×(⅔)=10V and the induced voltage is rectified to generate a DC voltage drop 10V (DC3) across the capacitor C2. Since the node F2 is grounded, the voltage at the end G2 is −10V. Therefore, the positive and negative driving voltages +15V and −10V required by the liquid crystal panel can be generated by the primary coil 242 and secondary coil 244 coupling to the rectification circuit 250. The extra DC/DC converter is not needed in the inverter 210 of the invention, thereby effectively reducing LCD cost.

### Embodiment Two

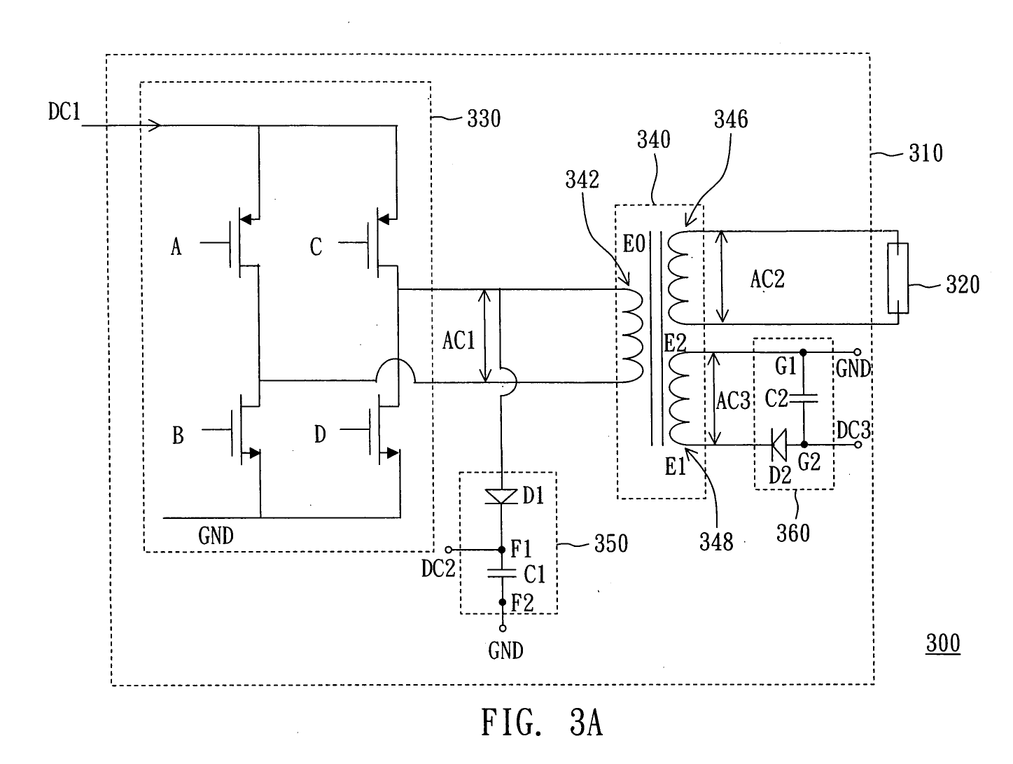

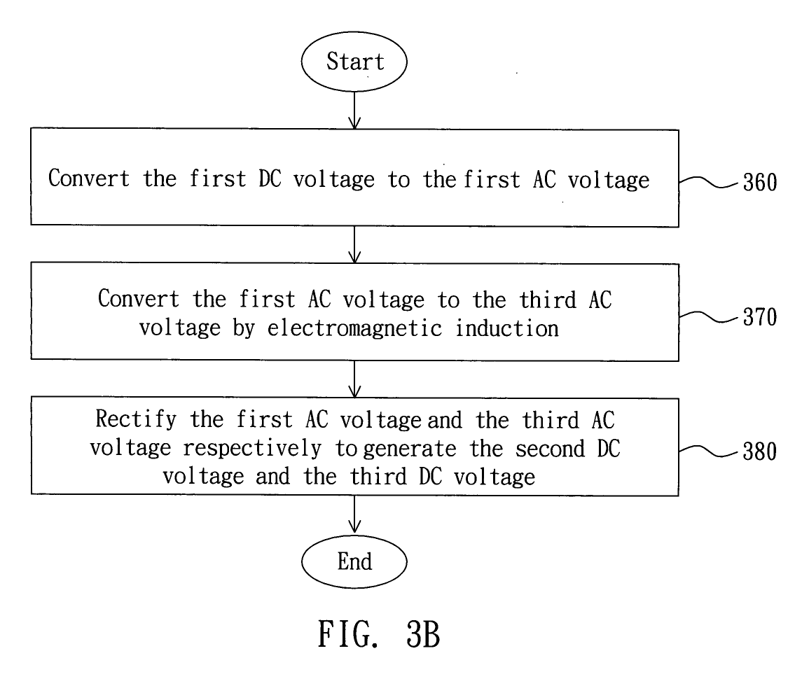

Referring to FIG. 3A, a circuit structure diagram of a backlight module of a LCD according to a second embodiment of the invention is shown. The backlight module 300, such as served as a light source for a small-scale liquid crystal panel, includes an inverter 310 and a lamp 320. The inverter 310 provides an AC driving voltage AC2 for driving the lamp 320. The lamp 320 is preferably a cold cathode fluorescent lamp (CCFL). The inverter 310 includes a power converting device 330, a transformer 340, a first rectification circuit 350 and a second rectification circuit 360. As shown in FIG. 3A, the power converting device 330, a full-bridge switch device as. preferred, is coupled to the first DC voltage DC1, such as 15V (the DC voltage DC1 falls in the range (5V, 24V) as preferred), and converts the DC voltage DC1 to a first AC voltage AC1 by high-frequency switching.

The transformer 340 includes a primary coil 342, a first secondary coil 346 and a second secondary coil 348. The primary coil 342 is coupled to the first AC voltage AC1 outputted by the power converting device 330. The first secondary coil 346 induces the first AC voltage AC1 by electromagnetic induction to output a second AC voltage AC2, up to several hundred to a thousand volts, for lighting up the lamp 320. The second secondary coil 348 also induces the first AC voltage AC1 to output a third AC voltage AC3 via an electromagnetic induction effect.

In this embodiment, the inverter 310 has the first rectification circuit 350 and the second rectification circuit 360, respectively coupled to the primary coil 342 and the second secondary coil 348. The first rectification circuit 350 rectifies the first AC voltage AC1 to output the second DC voltage DC2, such as the positive driving voltages +15V, and the second rectification circuit 360 rectifies the first AC voltage AC1 and outputting a third DC voltage DC3, such as a negative driving voltage −10V. Preferably, the first rectification circuit 350 includes a diode Dl and a capacitor C1, and the second rectification circuit 360 includes a diode D2 and a capacitor C2. The positive end of the diode D1 is coupled to an end E0 of the primary coil 342 while the negative end of the diode D1 is coupled to an end F1 of the capacitor C1. Another end F2 of the capacitor C1 is grounded. As noted,, the present invention generates a negative driving voltage −10V for the small LCD panel through the inverter 310.

Moreover, the positive end of the diode D2 is coupled to an end G2 of the capacitor C2, the negative end of the diode D2 is coupled to a first coil end E1 of the second secondary coil 348, and another end G1 of the capacitor C2 is coupled to a second coil end E2 of the second secondary coil 348, which is grounded.

FIG. 3B shows a flow chart of the method for generating DC voltages according to the second embodiment of the invention. First, in step 360, also with reference to FIG. 3A, use the power converting device 330, such as the full-bridge switch device to convert the first DC voltage DC1 (such as 15V) to the first AC voltage AC1 by high-frequency switching. If the threshold voltages of the transistors A, B, C and D are not considered, the AC voltage AC1 has an amplitude about 15V in the embodiment. Next, in step 370, use the transformer 340 to convert the first AC voltage AC1 to a third AC voltage AC3 by electromagnetic induction. Finally, in step 380, rectify the first AC voltage AC1 and the third AC voltage AC3 to respectively generate the second DC voltage DC2 and the third voltage DC3 by the first rectification circuit 350 and second rectification circuit 360.

The AC voltage AC1 is rectified by the diode D1 to generate a DC voltage drop 15V (DC2) across the capacitor C1. That is, the F1-end voltage is +15V. Besides, the winding number of the second secondary coil 348 can be properly arranged such that the third AC voltage AC3 induced by the second secondary coil 348 has an output amplitude about 10V. The induced voltage AC3 is then rectified by the diode D2 to generate a DC voltage drop 10V (DC3) across the capacitor C2. That is, the node G2 is −10V. Therefore, the positive and negative driving voltages +15V and −10V required by the liquid crystal panel can be generated by the primary coil 342 of the transformer 340 coupling to the first rectification circuit 350 and the second secondary coil 348 of the transformer 340 coupling to the second rectification circuit 360. The extra DC/DC converter is not needed in the inverter 310 of the invention, thereby effectively reducing LCD cost.

According to the disclosed embodiments, although the power converting device 230 or 330 of the backlight module 200 or 300 is exemplified by a full-bridge switch device, the backlight module 200 or 300 of the invention can also convert the DC voltage DC1 to the AC voltage AC1 by using a half-bridge switch device, a push-pull switch device or other alternative devices. By winding the first secondary coil 244 onto the transformer 240 and coupling the rectification circuit 250 to the coil 244 or coupling the first rectification circuit 350 to the primary coil 342 of the transformer 340, and coupling the second rectification circuit 360 to the second secondary coil 348, the positive and negative driving voltages required by the liquid crystal panel can be generated, thus reducing LCD cost.

Furthermore, although the rectification circuit 250 of the invention is exemplified to generate the driving voltages +15V and −10V by using the diodes D1, D2 and the capacitors C1 and C2, or the rectification circuits 350 and 360 are exemplified to respectively generate the driving voltages +15V and −10V by using the diode D1 and capacitor C1, and the diode D2 and capacitor C2, the polarity connection of the diode D1 or D2 can be reversed and properly arranged in the rectification circuit 250, 350, or 360. Or the rectification circuit 250 can also purely use a diode and a capacitor to generate a positive (or negative) driving voltage. Or the inverter 310 can generate the driving voltage DC2 by the first rectification circuit 350. The winding number N1 of the first secondary coil 244 can also be larger than the winding number M of the primary coil 242 by any proper relation. The winding number ratio of the first secondary coil 244 of the transformer 240 from the end E0 to E2 of the first secondary coil 244 can also be properly adjusted to generate various positive and negative driving voltages as needed. Or the rectification circuit 250, 350, or 360 can also be other rectification circuits of a complex type. Therefore, by using the power converting device 230 (or 330) and induction coil of the transformer 240 (or 340) coupled to the rectification circuit 250 (or 350 and 360), the backlight module 200 (or 300) can generate a variety of driving voltages for the LCD to achieve the purpose of reducing LCD cost, without departing from the scope of the invention.

The backlight module, inverter and the DC voltage generating method thereof disclosed by the above-mentioned embodiments of the invention has the following advantages:

1. The high driving voltages required by the LCD can be directly provided by the backlight module 200 having an extra secondary coil coupled to a rectification circuit on the transformer 240. Therefore, the extra DC/DC converter is not needed in the invention, and the cost for manufacturing LCD can be reduced.

2. Owing that the positive and negative driving voltages required by a small scale liquid crystal panel can have an error about 20%, the inverter according to the present invention can generate the driving voltages satisfying the required accuracy by coupling the rectification circuit to the transformer. Therefore, the LCD cost can be reduced by using the backlight module of the invention without influencing the quality of image display.

3. The required current from the positive and negative driving voltages need not to be very large (˜10 mA) on the small scale panel. Therefore, the extra secondary coil wound on the transformer of the backlight module in the invention has not to be large, and thus the volume of the transformer is not increased too much. The DC voltage generating method of the invention can thus be implemented under a limited current consideration. Moreover, winding one more coil on the transformer will not increase the cost and the required driving voltage can be adjusted by directly controlling the winding number of the primary or secondary coil. As a result, the LCD cost can be reduced.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all possible modifications and similar arrangements and procedures.

What is claimed is:

1. An inverter, applied to a backlight module, the inverter comprising:
a power converting device, coupled to a first DC voltage, for outputting a first AC voltage;
a transformer, comprising:
a primary coil, coupled to the first AC voltage outputted by the power converting device; and
a first secondary coil, for outputting a second AC voltage by inducing the first AC voltage; and
a rectification circuit, coupled to the first secondary coil, for rectifying the second AC voltage and outputting a second DC voltage.

2. The inverter according to claim 1, wherein the power converting device is a full-bridge switch device, a half-bridge switch device, or a push pull switch device.

3. The inverter according to claim 1, wherein the rectification circuit comprises a first diode and a first capacitor, a first end of the first diode is coupled to a first end of the first secondary coil, a second end of the first diode is coupled to a first end of the first capacitor, and a second end of the first secondary coil is coupled to a second end of the first capacitor.

4. The inverter according to claim 3, wherein the first end of the first diode is a positive end.

5. The inverter according to claim 3, wherein the first end of the first diode is a negative end.

6. The inverter according to claim 3, wherein the rectification circuit further comprises a second diode and a second capacitor, a first end of the second diode is coupled to a first end of the second capacitor, a second end of the second diode is coupled to an inner node of the first secondary coil, and a second end of the second capacitor is coupled to the second end of the first capacitor.

7. The inverter according to claim 1, wherein a winding number of the first secondary coil is larger than a winding number of the primary coil.

8. The inverter according to claim 1, wherein the transformer further comprises a second secondary coil for outputting a third AC voltage to a lamp by inducing the first AC voltage.

9. The inverter according to claim 8, wherein the lamp is a cold cathode fluorescent lamp.

10. An inverter, applied to a backlight module, the backlight module comprising a lamp, the inverter comprising:
a power converting device, coupled to a first DC voltage, for outputting a first AC voltage;
a transformer, comprising:
a primary coil, coupled to the first AC voltage outputted by the power converting device; and
a first secondary coil, for outputting a second AC voltage to drive the lamp by inducing the first AC voltage; and
a first rectification circuit, coupled to the primary coil, for rectifying the first AC voltage and outputting a second DC voltage.

11. The inverter according to claim 10, wherein the power converting device is a full-bridge switch device, a half-bridge switch device, or a push pull switch device.

12. The inverter according to claim 10, wherein the first rectification circuit comprises a first diode and a first capacitor, a first end of the first diode is coupled to one end of the primary coil, a second end of the first diode is coupled to a first end of the first capacitor, and a second end of the first capacitor is connected to a ground voltage.

13. The inverter according to claim 12, wherein the transformer further comprises a second secondary coil, for inducing the first AC voltage, and accordingly outputting a third AC voltage, the converter further comprises a second rectification circuit, coupled to the second secondary coil for rectifying the third AC voltage and accordingly outputting a third DC voltage.

14. The inverter according to claim 13, wherein the second rectification circuit further comprises a second diode and a second capacitor, a first end of the second diode is coupled to a first end of the second capacitor, a second end of the second diode is coupled to a first coil end of the second secondary coil, and a second end of the second capacitor is coupled to a second coil end of the second secondary coil.

15. A backlight module, comprising:
an inverter, comprising:
a power converting device, coupled to a first DC voltage, for outputting a first AC voltage;
a primary coil, coupled to the first AC voltage outputted by the power converting device;
a first secondary coil, for outputting a second AC voltage by inducing the first AC voltage; and
a second secondary coil, for outputting a third AC voltage by inducing the first AC voltage; and
a rectification circuit, coupled to the first secondary coil, for rectifying the second AC voltage and outputting a second DC voltage; and
a lamp, coupled to the third AC voltage.

16. The backlight module according to claim 15, wherein the power converting device is a full-bridge switch device, a half-bridge switch device, or a push pull switch device.

17. The backlight module according to claim 15, wherein the rectification. circuit comprises a first diode and a first capacitor, a first end of the first diode is coupled to a first end of the first secondary coil, a second end of the first diode is coupled to a first end of the first capacitor, and a second end of the first secondary coil is coupled to a second end of the first capacitor.

18. The backlight module according to claim 17, wherein the first end of the first diode is a positive end.

19. The backlight module according to claim 17, wherein the first end of the first diode is a negative end.

20. The backlight module according to claim 17, wherein the rectification circuit further comprises a second diode and a second capacitor, a first end of the second diode is coupled to a first end of the second capacitor, a second end of the second diode is coupled to an inner node of the first secondary coil, and a second end of the second capacitor is coupled to the second end of the first capacitor.

21. The backlight module according to claim 20, wherein the second end of the second diode is opposite to the first end of the first diode in polarity.

22. The backlight module according to claim 15, wherein a winding number of the first secondary coil is larger than a winding number of the primary coil.

23. The backlight module according to claim 15, is applied to a small scale liquid crystal display panel.

24. The backlight module according to claim 15, wherein the lamp is a cold cathode fluorescent lamp.

25. A DC voltage generating method, applied to an inverter of a backlight module, the inverter for receiving a first DC voltage, the method comprising:
converting the first DC voltage to a first AC voltage;
converting the first AC voltage to a second AC voltage by electromagnetic induction; and
rectifying the second AC voltage to generate a second DC voltage.

26. The method according to claim 25, converting the first DC voltage to the first AC voltage by a half-bridge switching method, a full-bridge switching method, or a push-pull switching method.

27. The method according to claim 25, wherein the step of rectifying the second AC voltage further comprises rectifying a portion of the second AC voltage to generate a third DC voltage.

28. The method according to claim 27, wherein the third DC voltage is a negative DC voltage.

29. The method according to claim 25, wherein the second AC voltage is larger than the first AC voltage.

30. The method according to claim 25, further comprising a step of converting the first AC voltage to a third AC voltage by an electromagnetic induction method.

31. The method according to claim 30, wherein the third AC voltage is for lighting up a cold cathode fluorescent lamp.
